(19) United States
(12) Patent Application Publication
(10) Pub. No.: US 2017/0342965 A1
(43) Pub. Date: Nov. 30, 2017

(54) IMPROVEMENTS RELATING TO WIND TURBINES

(71) Applicant: VESTAS WIND SYSTEMS A/S, Aarhus N (DK)

(72) Inventor: Ib Svend OLESEN, Randers (DK)

(21) Appl. No.: 15/536,091

(22) PCT Filed: Dec. 16, 2015
(86) PCT No.: PCT/DK2015/050398

§ 371 Date: Jun. 14, 2017

(30) Foreign Application Priority Data
Dec. 17, 2014 (DK) PA 2014 70793

(51) Int. Cl. F03D 17/00; F03D 1/06

(52) U.S. Cl. CPC F03D 17/00; F03D 1/06; F05B 2270/807; F05B 2240/60; F05B 2240/221; F05B 2270/821; F05B 2270/331

(57) ABSTRACT

A method of determining the shape of at least part of a wind turbine blade during operation of the wind turbine, the method comprising measuring first and second values of acceleration at one or more locations on the blade, the first and second values of acceleration being in substantially mutually perpendicular directions, and determining a shape parameter of the blade based upon the relative magnitudes of the measured first and second values of acceleration at the one or more locations.

### FIELD OF THE INVENTION

The present invention relates generally to wind turbines and more specifically to a method and system for determining the shape of a wind turbine blade during use of the wind turbine.

### BACKGROUND

Modern utility-scale wind turbines have rotors comprising very long, slender blades. FIG. 1 shows a typical wind turbine blade 10, which tapers longitudinally from a relatively wide root end 12 towards a relatively narrow tip end 14. A longitudinal axis L that passes through both the root end 12 and the tip end 14 when the blade 10 is substantially straight (as in FIG. 1) is also shown. The root end 12 of the blade 10 is circular in cross section. Outboard from the root, the blade 10 has an aerofoil profile 16 in cross section. A chord-wise axis C through the leading edge 18 and the trailing edge 20 of the blade 10 is also shown in FIG. 1.

The root 12 of the blade 10 is typically connected to a hub of the rotor via a pitch mechanism, which turns the blade about the longitudinal pitch axis L in order to vary the pitch of the blade. The longitudinal axis L is generally perpendicular to the axis of rotation of the rotor. Varying the pitch of a blade varies its angle of attack with respect to the wind. This is used to control the energy capture of the blade, and hence to control the rotor speed so that it remains within operating limits as the wind speed changes. In low to moderate winds it is particularly important to control the pitch of the blades in order to maximise their energy capture, and to maximise the productivity of the wind turbine.

The energy capture of a wind turbine blade generally increases moving from the root towards the tip. Hence, the inboard or root part 12 of the blade 10 tends to capture the least energy, whilst the outboard or tip part 14 of the blade 10 tends to capture the most energy. Precise control over the pitch angle of the outboard part of the blade is therefore desirable in order to maximise the output of the wind turbine.

Modern wind turbine blades are typically 50-80 metres in length, and there is a constant drive to develop longer blades to capture more energy from the wind. These blades are generally made from composite materials such as glass-fibre reinforced plastic (GFRP). The blades are therefore relatively flexible and inevitably bend and twist to an extent during operation. The relatively narrow outboard part of the blade is particularly susceptible to twisting and bending.

Whilst the pitch mechanism allows precise control over the angle of the root of the blade, this does not necessarily reflect the angle of other points on the blade, particularly nearer to the tip, which is more susceptible to bending and twisting, as mentioned above. In extreme cases, bending of the blade could result in the blade tip colliding with a tower section of the wind turbine. It is therefore desirable to provide a method and apparatus for determining the shape (or behaviour) of the blade such that, for example, the position of the tip or the overall load on the blade may be determined. Present systems include combinations of optical and strain sensors, which are both expensive and susceptible to damage in the extreme weather conditions to which wind turbine blades are commonly subjected.

Against this background, the present invention aims to provide an alternative solution for determining the shape or behaviour of a blade which is relatively inexpensive and more robust than the prior art solutions mentioned above.

### SUMMARY OF THE INVENTION

According to one aspect of the present invention there is provided a method determining the shape of at least part of a wind turbine blade during operation of the wind turbine, the method comprising measuring first and second values of acceleration at one or more locations on the blade, the first and second values of acceleration being in substantially mutually perpendicular directions. The method further comprises determining a shape parameter of the blade based upon the relative magnitudes of the measured first and second values of acceleration at the one or more locations.

The present invention provides an inexpensive and robust method for determining the degree of bending caused by wind loads at one or more points of the blade with a high degree of accuracy.

The shape parameter may be a blade bending angle and/or a position of the one or more locations on the blade. The blade bending angle may be the angle between a rotor axis of the wind turbine and the direction of the first value of acceleration at the one or more locations. This advantageously allows the current state of the blade to be determined, or a future state of the blade to be predicted, so that appropriate control strategies may be employed.

Determining the shape parameter may comprise calculating a centripetal acceleration and/or a centrifugal acceleration of one or more locations of the blade based upon the measured first and second values of acceleration. A centripetal force and/or a centrifugal force at the one or more locations on the blade may then be calculated based upon the calculated centripetal acceleration and/or centrifugal acceleration.

The shape parameter may be determined using trigonometry and/or a look-up table.

In some embodiments, the location of a tip of the blade is determined based upon the determined shape parameter. This is important in order to assess whether, for example, the blade is bending to an extent where it may strike a tower of the wind turbine.

Alternatively, or in addition, the method may comprise approximating an overall shape of the blade and/or the load on the blade based upon the determined shape parameter. The overall shape of the blade may further be based upon the position of a root end of the blade. The positions of the root end is substantially unaffected by external loads such as wind and so provides a good reference point when determining other blade characteristics.

The method may comprise sending a control signal to at least one component of the wind turbine, the control signal being based upon at least one of the determined shape parameter, the location of the tip, the overall shape of the blade and the determined load on the blade. This allows energy capture to be maximised and/or the potential for damage to the wind turbine blades to be minimised.

In some embodiments, the method comprises measuring first and second values of acceleration at a plurality of locations on the blade, the first and second values of acceleration being in substantially mutually perpendicular directions, and the plurality of locations being mutually spaced along the length of at least part of the blade. Increasing the number of locations along the blade at which the acceleration is measured increases the accuracy of the subsequently approximated blade characteristics.

According to another aspect of the present invention there is provided a system for determining the shape of at least part of a wind turbine blade during operation of the wind turbine, the system comprising an accelerometer located at a first location on the blade, the accelerometer being configured to measure first and second values of acceleration in substantially mutually perpendicular directions at the first location on the blade. The system also comprises a processor configured to determine a shape parameter of the blade based upon the relative magnitudes of the measured first and second values of acceleration at the first location.

The system may comprise a plurality of accelerometers mutually spaced along the length of at least part of the blade, each accelerometer being configured to measure first and second values of acceleration in substantially mutually perpendicular directions at the location of the respective accelerometer, and the processor being configured to determine a shape parameter of the blade based upon the relative magnitude of the measured first and second values of acceleration at one or more of the respective locations.

The or each accelerometer may be a two-axis accelerometer. This provides a practical way of measuring the acceleration in two substantially mutually perpendicular directions; however, two single-axis accelerometers may be arranged to provide the same function.

In some embodiments the processor is configured to calculate a blade bending angle and/or a position of the blade at the location of a respective accelerometer based upon the relative magnitudes of the measured first and second values of acceleration as measured by that accelerometer.

The or each accelerometer may be a safety-rated accelerometer. The measured values of acceleration may then be communicated via safety-rated communication means, such as optical fibres or other types of cable, to a safety control system. The safety control system may comprise the processor configured to determine a shape parameter of the blade, or may comprise a separate safety processor.

The processor and/or the separate safety processor may be located in a nacelle of the wind turbine. In addition, or alternatively, the system may comprise a controller for controlling at least one component of the wind turbine based upon at least one of the determined shape parameter, a determined location of a tip of the blade, a determined overall shape of the blade and a determined load on the blade. The at least one component may be a pitch mechanism connecting a rotor hub of the wind turbine to the blade in order to vary the pitch of the blade. The controller may be a safety controller or the system may additionally comprise a separate safety controller. Where the system comprises a separate safety controller, the safety controller may override control signals from the controller if the operation of the wind turbine blades is deemed to be unsafe, for example, if the blade tip is likely to strike a tower of the wind turbine or if the load on the blade is greater than a threshold value. Such an override may comprise the safety controller controlling the blade pitch. The inclusion of a safety controller allows the blade to be designed so that, for example, it is less stiff and/or that it is longer. Both of these design features increase the susceptibility of the blade to bending; however, the presence of a safety system means that damage caused by any potentially severe blade bending may be prevented.

According to yet another aspect of the present invention there is provided a wind turbine comprising any of the systems disclosed above.

### BRIEF DESCRIPTION OF THE DRAWINGS

FIG. 1, which is a perspective illustration of an exemplary wind turbine blade having a circular cross-section at the root, and an aerofoil cross-section profile outboard from the root, has already been described above by way of background to the present invention.

In order that the present invention may be more readily understood, embodiments of the invention will now be described, by way of non-limiting example, with reference to the following figures, in which:

FIG. 2a is a front view of an exemplary wind turbine, the wind turbine comprising a two-axis accelerometer positioned near to the tip of each wind turbine blade;

FIG. 2b is a side view of the wind turbine shown in FIG. 2a, further showing a control unit located in a nacelle of the wind turbine;

FIG. 3a is a schematic illustration of the cross-section of one of the blades shown in FIGS. 2a and 2b relative to the wind turbine tower in the case where the wind turbine blade is substantially straight;

FIG. 3b shows the wind turbine blade cross-section of FIG. 3a in the case where the wind turbine blade is bent;

FIG. 4 is a flow diagram which illustrates a process according to an embodiment of the invention for determining characteristics of the blade shown in FIGS. 3a and 3b, based on values measured by the two-axis accelerometer positioned on the blade; and

FIGS. 5a and 5b show the blade configurations of FIGS. 3a and 3b respectively, and further show different dimensions associated with said configurations.

### DETAILED DESCRIPTION

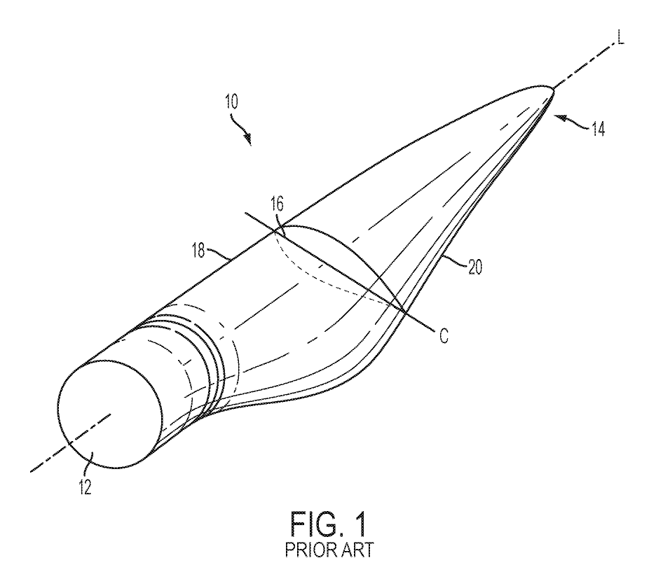

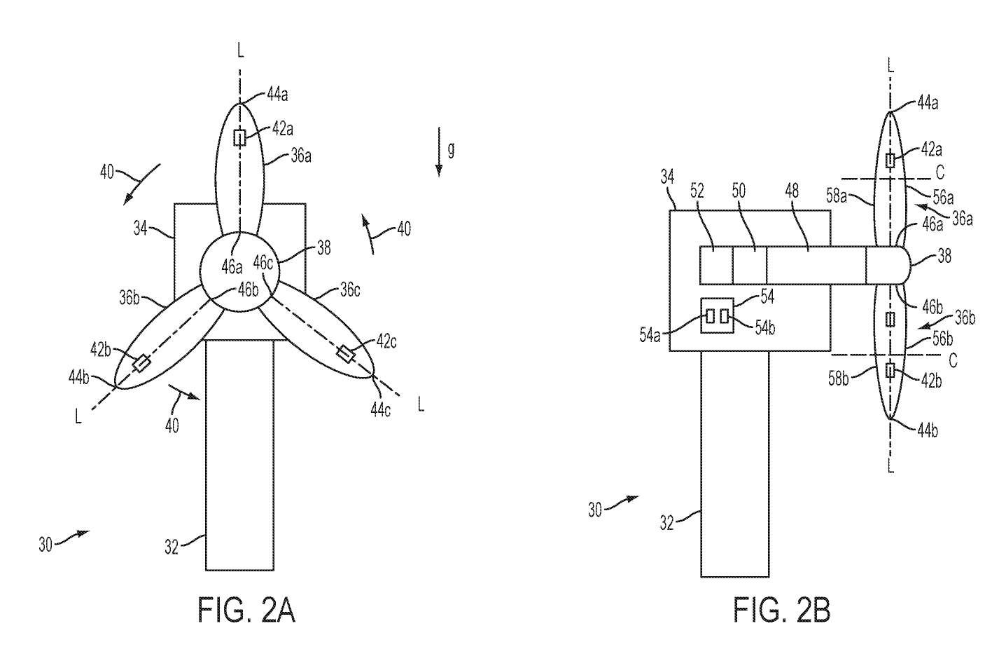

FIGS. 2a and 2b show front and side views respectively, of one embodiment of a horizontal axis wind turbine 30 comprising a tower 32 and a nacelle 34. As best illustrated in FIG. 2a, the wind turbine 30 further comprises a rotor-hub assembly comprising three turbine blades 36a, 36b, 36c affixed to a central hub 38 via respective pitch mechanisms (not illustrated). The blades 36a, 36b, 36c have a cross-sectional profile 16 as illustrated in FIG. 1, and are arranged to cause an anti-clockwise rotation of the rotor-hub, as indicated by the directional arrows 40, when wind is incident on the blades 36a, 36b, 36c in a direction substantially perpendicular to and into the plane of the page.

Each blade 36a, 36b, 36c of the rotor-hub assembly is configured with a respective two-axis accelerometer 42a, 42b, 42c located near the blade tips 44a, 44b, 44c. This is discussed in greater detail below. As illustrated in FIG. 2b, located in the nacelle 34 is a generally horizontal main shaft 48 connected at a front end to the central hub 38 and at a rear end to a gearbox 50 which in turn is connected to a generator 52. A control unit 54 is located adjacent to the generator 52.

The control unit 54 comprises a processor 54a for determining values indicative of certain characteristics of the blades 36a, 36b, 36c based on values measured by the accelerometers 42a, 42b, 42c. The control unit 54 also comprises a controller 54b for sending control signals based on said determined characteristics to different components of the wind turbine 30. This is also discussed in greater detail below.

Also shown in FIGS. 2a and 2b are longitudinal axes L associated with each blade 36a, 36b, 36b, as illustrated in FIG. 1. FIG. 2b shows chord-lines C passing through respective leading edges 56a, 56b (56c not shown) and trailing edges 58a, 58b (58c not shown), also as illustrated in FIG. 1.

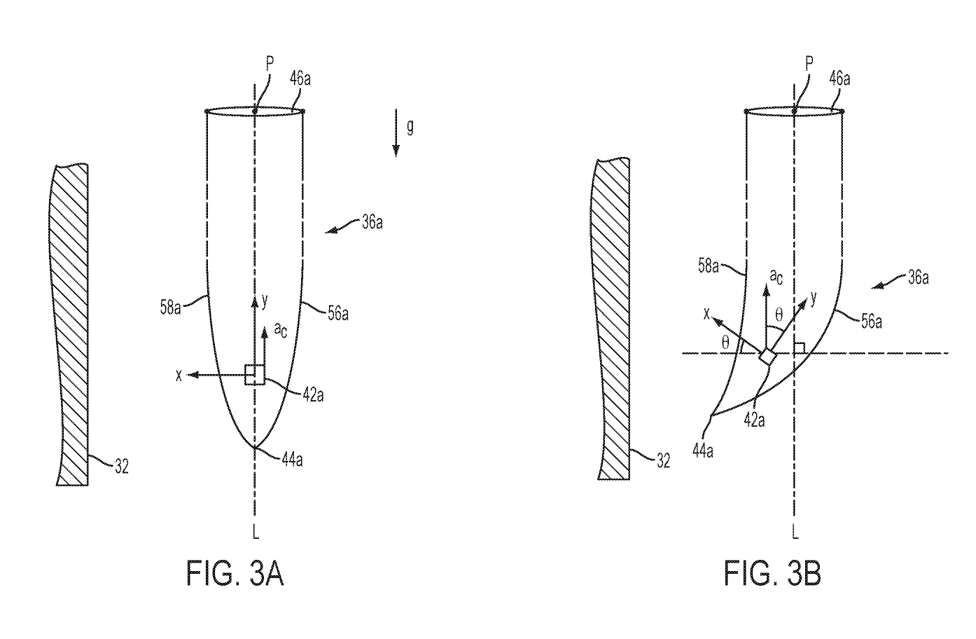

Blade bending typically occurs when a wind turbine blade is subjected to a large external load generally perpendicular to the blade's longitudinal axis L. This can cause the blade to bend, which may result in significant displacement of the blade tip from the straight longitudinal axis L. Blade bending is best defined herein with reference to FIGS. 3a and 3b.

FIG. 3a is a schematic illustration of a cross-sectional side view of the blade 36a (as in FIG. 2b). In this case the blade 36a is substantially straight and the blade tip 44a is substantially vertically below the blade root 46a. FIG. 3b shows the blade 36a when bent; that is, in the case when the outboard part of the blade is subjected to wind loads, as mentioned above. When the blade 36a is substantially straight, the L axis passes through both the tip end 44a and a point P at a root end 46a of the blade 36a. When the blade 36a is bent, the L axis remains substantially perpendicular to the axis of rotation of the central hub 38, still passing through P but not passing through the blade tip 44a. It should also be emphasised that the blade 36a is long and slender; that is, its length in the direction defined by the L axis is much greater than in a direction substantially perpendicular to the L axis from the leading edge 56a to the trailing edge 58a.

As mentioned above, the two-axis accelerometer 42a is located in the vicinity of the blade tip 44a and is positioned such that the L axis passes through it; however, in other embodiments the two-axis accelerometer 42a may be located at any point on the blade 36a. The two axis accelerometer 42a may be positioned on the surface of, or within, the blade 36a and comprises two substantially mutually perpendicular single-axis accelerometers of any type known in the art (for example, a Memsic 2125 Dual-axis Accelerometer) and packaged as a single unit. In other embodiments, the two single-axis accelerometers need not be packaged as a single unit and may be two separate units positioned substantially adjacent each other.

The two axis accelerometer 42a is configured to measure the acceleration of the particular point of the blade 36a at which it is positioned. The two-axis accelerometer 42a is positioned such that when the blade 36a is substantially straight (as shown in FIG. 3a), the acceleration measured in the direction of a first ‘Y’ axis coincides with the direction of the longitudinal axis L. The two-axis accelerometer 42a also measures the acceleration in a second ‘X’ axis that is substantially perpendicular to the Y axis. Expressed in other terms, when the blade 36a is substantially straight, the X axis is substantially parallel to the axis of rotation of the central hub 38 and main shaft 48, while the Y axis is substantially perpendicular to said axis of rotation.

When the blade 36a is bent (as shown in FIG. 3b), the two-axis accelerometer 42a is displaced such that the X axis is no longer substantially parallel to the axis of rotation and the Y axis is no longer substantially parallel to the L axis. The X and Y axes do, however, remain substantially mutually perpendicular. Note that the directions of positive X and Y shown in FIGS. 3a and 3b are for illustrative purposes only and may be adapted as preferred. Note also that the two-axis accelerometer 42a may be arranged on the blade 36a such that the X axis is not substantially parallel to the axis of rotation and the Y axis is not substantially parallel to the L axis for a substantially straight blade.

A blade bending angle θ (0≦θ≦π/2) at the location of the two-axis accelerometer 42a on the blade 36a is defined as the angle between the X axis and the axis of rotation of the central hub and main shaft 48. Equivalently, the blade bending angle θ at the location of the two-axis accelerometer 42a may be defined as the angle between the Y axis and the direction of the L axis. In the subsequent discussion of the invention, this definition of the blade bending angle will be applied. It will be appreciated, however, that the bending angle could be defined relative to any other suitable arbitrary reference axes, and so this definition should not be interpreted as unduly limiting the scope of the present invention. For example, the blade bending angle may instead be defined as the angle between the Y axis and the axis of rotation, that is, the angle taking the value π/2−θ according to the geometry of FIG. 3b.

As the blade 36a rotates, the two-axis accelerometer 42a has a centripetal acceleration a, directed towards the centre of the circular path it is following. Equivalently, the centripetal acceleration α_{c} is in a direction substantially perpendicular to the axis of rotation of the central hub 38, that is, in the direction defined by the longitudinal axis L. Note that this means that in the presently described embodiment, θ may be defined as the angle between the Y axis and the direction of centripetal acceleration of the blade 36a at the location of the two-axis accelerometer 42a. In the case when the blade 36a is substantially straight (as shown in FIG. 3a), the Y direction corresponds to the direction defined by the L axis so that the acceleration in the Y direction, denoted by α_{Y}, is equal to the centripetal acceleration α_{c}, and the acceleration in the X direction, denoted by α_{X}, is zero. When the blade 36a is bent (as shown in FIG. 3b), however, a component of the centripetal acceleration is in the X direction such that α_{X}≠0 and α_{Y}<α_{c}.

For a given blade profile, the bending angle θ is different depending on the location of the two-axis accelerometer 42a along the blade's length, and therefore positioning the two-axis accelerometer 42a substantially in the vicinity of the blade tip 44a ensures that the determined blade bending angle θ is an accurate reflection of the state of the blade tip 44a, which may be the part of the blade 36a that is of most interest. The two-axis accelerometer 42a may, however, be positioned at any location along the blade's length.

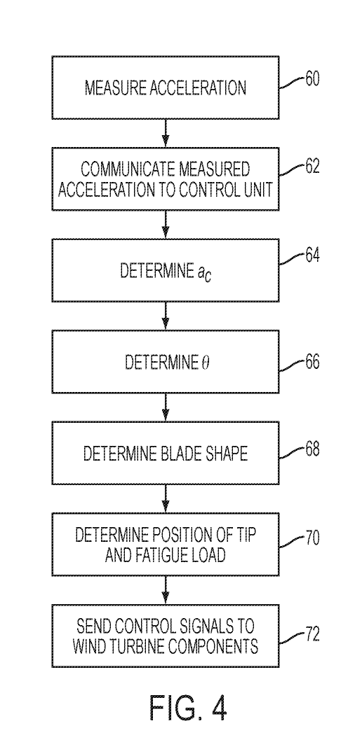

FIG. 4 illustrates a process according to the presently described embodiment of the invention for determining characteristics of the blade 36a shown in FIGS. 3a and 3b, based on values measured by the two-axis accelerometer 42a positioned on said blade 36a. In particular, at step 60 the acceleration in the X and Y directions α_{X} and α_{Y}, respectively, is measured by the two-axis accelerometer 42a. These measured values of acceleration are then communicated to the control unit 54 at step 62. Optical fibres may be used to transmit signals indicative of the measured values of acceleration from the accelerometers 42a, 42b, 42c to the control unit 54. Such optical fibres (not shown in the figures) extend longitudinally through the blades 36a, 36b, 36c, and their use advantageously avoids electrically conducting apparatus within the blades 36a, 36b, 36c, which may attract lightening in adverse weather conditions. Alternatively, other types of cables may be used to transmit signals to the control unit 54.

At step 64, the control unit 54 uses Pythagoras' theorem to determine the centripetal acceleration α_{c} using the relationship

α_{c}=\sqrt{a_{X}²+α_{Y}²},

and then determines the blade bending angle θ at step 66 using simple trigonometry, which gives the relationship

$$θ = {cos}^{- 1} ( \frac{{a}_{Y}}{{a}_{c}} ) = {cos}^{- 1} ( \frac{{a}_{Y}}{\sqrt{{a}_{X}^{2} + {a}_{Y}^{2}}} ) .$$

In the geometry defined in FIGS. 3a and 3b, if sgn(α_{X})=sgn(α_{c}), then the blade 36a is bending ‘inwardly’ towards the tower 32 (as shown in FIG. 3b), and if sgn(α_{X})≠sgn(α_{c}), then the blade 36a is bending ‘outwardly’ away from the tower 32. The centripetal force may readily be determined using the calculated centripetal acceleration. Note that, in cases where the value of αc itself is not of interest, step 64 may be skipped and θ may be determined directly using the values of α_{X} and α_{Y}. Note also that the above relationship for calculating θ may readily be adapted by the skilled person in dependence on the particular definition of the bending angle and the particular arbitrary reference axes selected. In other embodiments, the skilled person may choose to calculate the centrifugal acceleration (and centrifugal force) instead of, or in addition to, the centripetal acceleration (and centripetal force) in an equivalent manner.

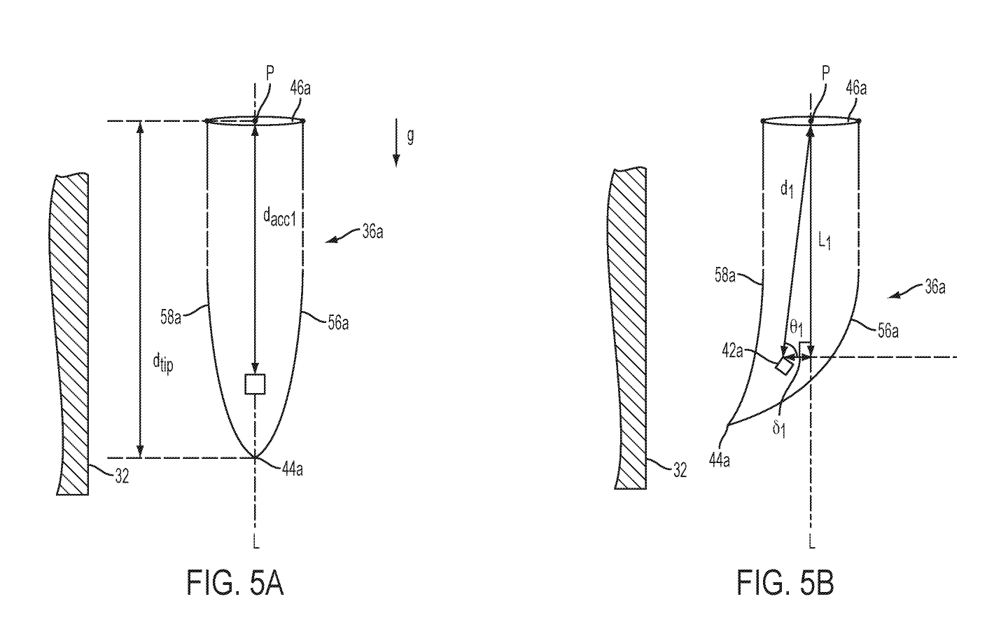

Once θ has been determined then the control unit 54 may approximate the shape of the blade 36a at step 68. The shape of the blade 36a may alternatively be approximated without first determining the bending angle θ. One method of approximating this shape is now described with reference to FIGS. 5a and 5b.

FIG. 5a shows the blade 36a in the same arrangement as in FIG. 3a. In particular, FIG. 5a shows that for a substantially straight blade, the accelerometer 42a is a known, constant distance d_{acc1} from the point P at the blade root 46a, and the blade tip 44a is a known, constant distance dₜᵢₚ from the point P at the blade root 46a. FIG. 5b shows the blade 36a in the same arrangement as in FIG. 3b. In particular, FIG. 5b shows that the accelerometer 42a is a distance d₁ from the point P at the blade root 46a at an angle θ₁ to the axis of rotation (which is substantially perpendicular to L). Note that d₁ varies with θ₁, that is, d₁=d₁(θ₁). The displacement of the two-axis accelerometer 42 from the point P is a distance l₁ in the direction of L and a distance δ₁ in the direction of the axis of rotation.

For a relatively small degree of bending of the blade 36a then the approximations θ₁≈θ and d₁≈d_{acc1} may be made (where θ is as defined above with reference to FIG. 3b). The shape of the blade 36a may then be approximated as the straight line with gradient tan θ passing through the point P.

The described embodiment comprises blades 36a, 36b, 36c each with a single two-axis accelerometer 42a, 42b, 42c; however, this may of course be extended so that the blades include a plurality of two-axis accelerometers spaced along their length. A greater number of two-axis accelerometers would allow the shape of the blade to be approximated more accurately (and, specifically, not be restricted to a straight-line approximation). An arrangement comprising two accelerometers located at different points along the length of the blade 36a would allow the shape of the blade to be approximated as a polynomial of degree two (using the calculated positions of the location of each of the two accelerometers and the point P at the blade root 46a) by, for example, Newtonian interpolation. In such a case, and with reference to FIG. 5b, the displacement of the two-axis accelerometer 42a in the direction of the L axis, l₁, and in the direction of the axis of rotation, δ₁, may be approximated by simple trigonometry using the known values d_{acc1} and θ to give

l₁≈d_{acc1} sin θ and δ₁≈d_{acc1} cos θ.

The location of a second two-axis accelerometer (not pictured in FIG. 5b, but positioned at distances l₂ and δ₂ from P in the L direction and in the direction of the axis of rotation, respectively) may be determined similarly using a known distance between the point P and the second two-axis accelerometer, d_{acc2}, together with a determined value of θ at this location using measured values of acceleration (where the determined values of θ are different at the locations of the different two-axis accelerometers). The shape of the blade 36a may then be approximated as the curve passing through the points P, (l₁, δ₁) and (l₂, δ₂). This may readily be extended to an arrangement comprising n two-axis accelerometers on the blade 36a.

Once the shape of the blade 36a has been approximated, then the location of the blade tip 44a and the fatigue loads on the blade may be determined at step 70. As mentioned above, the distance between the blade root 46a and the blade tip 44a for a substantially straight blade 36a is the known, constant value dₜᵢₚ (as shown in FIG. 5a). For example, in the presently described embodiment in which there is a single two-axis accelerometer 42a on the blade 36a, the position of the blade tip 44a relative to the point P at the blade root 46a may readily be approximated as being a distance dₜᵢₚ sin θ in the direction of L and a distance dₜᵢₚ cos θ in the direction of the axis of rotation.

This calculation may be changed as appropriate in the case of two or more two-axis accelerometers along the blade's length (i.e. when the approximated shape is not a straight line). This calculated blade tip position may be used to determine, for example, whether the blade tip 36a is in danger of colliding with the tower 32. In other embodiments, the location of the blade tip 44a may be determined without first approximating the blade shape.

The approximated shape of the blade may be used to calculate the strain experienced by the blade surface because of blade bending, and therefore to calculate the overall load on the blade or the load at one or more locations on the blade.

At step 72 the control unit 54 sends control signals to, for example, adjust the pitch angle of the rotor assembly so that a potential collision between the blade tip 36a and the tower 32 is avoided.

The above method allows various characteristics (e.g. local blade angle, blade shape, blade tip position, load) of a given wind turbine blade to be determined at a given moment in time. By determining one or more of these characteristics at a plurality of successive points in time, then a prediction may be made as to, for example, the path that the blade tip may follow in a future time period. This allows control strategies that are necessary to the continued smooth operation of the wind turbine to be implemented before a critical situation (e.g. excessive blade bending or excessive loads on the blade) arises.

The above-described embodiment mainly considers an arrangement with one two-axis accelerometer 42a on the blade 36a. As mentioned, however, there may be a plurality of two-axis accelerometers on each blade of the wind turbine 30. For example, a plurality of two-axis accelerometers spaced along the length of the blade 36a between the root end 46a and the tip end 44a would allow the blade bending angle to be determined at a plurality of locations along the blade 36a.

Alternatively, there may be one or more two-axis accelerometers positioned on one blade of the wind turbine only. In this case it may be assumed that the other blades have similar characteristics; that is, that the blades, for example, experience similar loads or degrees of bending at the blade tips. This approach is advantageous from a cost perspective in that less hardware is needed; however, such assumptions regarding the similarity of certain characteristics between blades may not always be appropriate.

The presently described embodiment may be extended to measure the acceleration at one or more given points on a blade in three substantially mutually perpendicular directions by using one or more three-axis accelerometers. This would allow bending of the blade in more than one direction to be determined or to determine the degree of blade twisting at a given point. A more sophisticated approximation (i.e. an extra dimensional approximation) for the shape of the blade would be possible in this case.

For ease of understanding, the presently described embodiment (as shown in FIGS. 2, 3 and 5) considers an idealised arrangement in which the axis of rotation is perpendicular to the direction of gravitational force. In practice, the main shaft 48 of the wind turbine 30 is typically tilted by a few degrees such that a (small) component of the acceleration due to gravity is in the X direction (as defined in FIGS. 3a and 3b); however, given that the acceleration due to gravity and the degree of tilt of the main shaft 48 will be known, constant values, then this effect may readily be incorporated by the skilled person into the above-described process. Furthermore, on some wind turbines the blades may be mounted on the rotor axis such that their tip points away from, or towards, the nacelle by a few degrees (typically 1 to 5 degrees). As above, this will be a known, constant value and so this effect may also be incorporated by the skilled person into the above-described method.

Also, the or each wind turbine blade may be subject to vibrations and/or other types of naturally-occurring movement that could affect the measured values from the or each accelerometer. The method may readily be adapted to remove such unwanted noise in the measured values by using a simple low-pass filter or by using more advanced methods.

Alternatively, or in addition, the above-described method may make use of one or more look-up tables in conjunction with the measured values of acceleration to determine characteristics of the blade such as the blade bending angle, the position of one or more locations of the blade, the overall shape of the blade and the overall load on the blade.

Whilst the herein described embodiments relate to a wind turbine comprising three blades, this is non-limiting and for illustrative purposes only. The present method may be used to calculate characteristics relating to blade bending for a wind turbine comprising any number of turbine blades.

In the above examples, the shape of the blade can be inferred from the relative magnitudes of the mutually-perpendicular accelerations. Offline calibration tests may be performed to generate a suitable look-up table that correlates the relative magnitudes of the accelerations with the bending characteristics of the blade. In use, therefore, the blade shape may be inferred from the look-up table based upon the relative magnitudes of the accelerations. This advantageously avoids the need for performing calculations online.

The embodiments described herein are provided for illustrative purposes only and are not to be construed as limiting the scope of the invention, which is defined in the following claims.

1. A method of determining the shape of at least part of a wind turbine blade during operation of the wind turbine, the method comprising:
measuring first and second values of acceleration at one or more locations on the blade, the first and second values of acceleration being in substantially mutually perpendicular directions; and
determining a shape parameter of the blade based upon the relative magnitudes of the measured first and second values of acceleration at the one or more locations.

2. A method according to claim 1, wherein the shape parameter is a blade bending angle and/or a position of the one or more locations on the blade.

3. A method according to claim 2, wherein the blade bending angle is the angle between a rotor axis of the wind turbine and the direction of the first value of acceleration at the one or more locations.

4. A method according to claim 1, the method comprising measuring first and second values of acceleration at a plurality of locations on the blade, the first and second values of acceleration being in substantially mutually perpendicular directions, and the plurality of locations being mutually spaced along the length of at least part of the blade.

5. A method according to claim 1, wherein determining the shape parameter comprises calculating a centripetal acceleration and/or a centrifugal acceleration of the one or more locations of the blade based upon the measured first and second values of acceleration.

6. A method according to claim 5, comprising calculating a centripetal force and/or a centrifugal force at the one or more locations on the blade based upon the calculated centripetal acceleration and/or centrifugal acceleration.

7. A method according to claim 1, wherein determining the shape parameter comprises using trigonometry and/or a look-up table.

8. A method according to claim 1, comprising determining the location of a tip of the blade based upon the determined shape parameter.

9. A method according to claim 1, comprising approximating an overall shape of the blade and/or a load on the blade based upon the determined shape parameter.

10. A system for determining the shape of at least part of a wind turbine blade during operation of the wind turbine, the system comprising:
an accelerometer located at a first location on the blade, the accelerometer being configured to measure first and second values of acceleration in substantially mutually perpendicular directions at the first location on the blade; and
a processor configured to determine a shape parameter of the blade based upon the relative magnitudes of the measured first and second values of acceleration at the first location.

11. A system according to claim 10, comprising a plurality of accelerometers mutually spaced along the length of at least part of the blade, each accelerometer being configured to measure first and second values of acceleration in substantially mutually perpendicular directions at the location of the respective accelerometer, and the processor being configured to determine a shape parameter of the blade based upon the relative magnitude of the measured first and second values of acceleration at one or more of the respective locations.

12. A system according to claim 10, wherein at least one accelerometer is a two-axis accelerometer.

13. A system according to claim 10, wherein at least one accelerometer is a safety-rated accelerometer.

14. A system according to claim 10, comprising a controller for controlling at least one component of the wind turbine based upon at least one of the determined shape parameter, a determined location of a tip of the blade, a determined overall shape of the blade and a determined load on the blade.

15. (canceled)

16. A wind turbine, comprising:
a tower;
a nacelle disposed on the tower;
a rotatable shaft at least partially disposed in the nacelle and having a rotor disposed on one end thereof;
a plurality of blades disposed on the rotor;
an accelerometer located at a first location on at least one blade of the plurality of blades, the accelerometer being configured to measure first and second values of acceleration in substantially mutually perpendicular directions at the first location on the blade; and
a processor configured to determine a shape parameter of the blade based upon the relative magnitudes of the measured first and second values of acceleration at the first location.

17. A wind turbine according to claim 16, comprising a plurality of accelerometers mutually spaced along the length of at least part of the blade, each accelerometer being configured to measure first and second values of acceleration in substantially mutually perpendicular directions at the location of the respective accelerometer, and the processor being configured to determine a shape parameter of the blade based upon the relative magnitude of the measured first and second values of acceleration at one or more of the respective locations.

18. A wind turbine according to claim 16, wherein at least one accelerometer is a two-axis accelerometer.

19. A wind turbine according to claim 16, wherein at least one accelerometer is a safety-rated accelerometer.

20. A wind turbine according to claim 16, comprising a controller for controlling at least one component of the wind turbine based upon at least one of the determined shape parameter, a determined location of a tip of the blade, a determined overall shape of the blade and a determined load on the blade.
